(19) United States
(12) Patent Application Publication
(10) Pub. No.: US 2002/0053773 A1
(43) Pub. Date: May 9, 2002

(54) Drill chuck with hardened body

(75) Inventor: Gunter Horst Rohm, Sontheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH

(21) Appl. No.: 09/930,740

(22) Filed: Aug. 15, 2001

(30) Foreign Application Priority Data
Aug. 16, 2000 (DE) 20014337.9

(51) Int. Cl. B23B 31/12

(52) U.S. Cl. 279/62

(57) ABSTRACT

A chuck body centered on an axis is formed with a rear axially open mounting hole, a front axially open tool recess, a passage extending axially between the hole and the recess, and a plurality of angled guide passages spaced about the axis and opening into the recess. Respective jaws displaceable generally axially in the passages each have a row of radially outwardly directed teeth. A tightening ring rotatable about the axis but axially fixed on the chuck body has an internal screwthread meshing with the teeth of the jaws. The chuck body has inner and outer nitrided surfaces hardened by nitrocarburizing.

### FIELD OF THE INVENTION

The present invention relates to a chuck. More particularly this invention concerns a chuck for a hammer drill.

### BACKGROUND OF THE INVENTION

A standard drill chuck has a chuck body centered on an axis and formed on the axis with a rearwardly open hole or other formation adapted for engagement by a spindle or the like of a drive unit, with a plurality of forwardly open angled guide passages adapted to receive respective jaws for gripping a tool in a forwardly open recess at a front end of the chuck body, and with a central passage connecting the tool recess with the spindle hole. The jaws have outer edges formed with teeth that mesh with an internal screwthread of a tightening ring rotatable on the body about the axis and constrained against axial movement relative to the body so that, when the tightening ring is rotated, the jaws are moved forward to grip the tool or backward to release it. As a rule the tightening ring is received in a groove whose front flank is formed by a rearwardly directed shoulder of the chuck body and whose rear flank is formed by a roller bearing in turn bearing axially backward on a forwardly directed shoulder of the chuck body. A locking mechanism may be provided for arresting the tightening ring to prevent the chuck from loosening when in use.

The chuck body is of relatively complex construction with an outside surface that is formed by turning and passages and bores that must be drilled out, all to very tight tolerances. Cold machining practices are used to prevent thermal deformation of the part during its manufacture.

In use such a drill chuck is exposed to substantial dirt in the form of particles generated by a drilling process. These particles find their way back up into the chuck and, being extremely hard and gritty, can cause substantial wear when they get between the jaws and the chuck body. The jaws can loosen as they and their guide passages wear, and the engagement between the jaw teeth and the tightening-ring screwthread can also get loose.

U.S. Pat. No. 5,580,197 describes such a chuck provided with grit-clearing passages that extend from the rear end of the tool recess to outside the body, so that such particles can be cleared from the chuck by centrifugal force. While such passages do reduce the amount of grit in the chuck, they do not limit it altogether, and they require yet another machining step in the manufacture of the chuck, making it more expensive. The problem is that the grit adheres to the steel surface of the chuck body, getting ground into it and forming a durable layer that increases wear of anything contacting it.

### OBJECTS OF THE INVENTION

It is therefore an object of the present invention to provide an improved drill chuck.

Another object is the provision of such an improved drill chuck which overcomes the above-given disadvantages, that is which is inexpensive to manufacture yet highly resistant to damage from drilling grit.

### SUMMARY OF THE INVENTION

These objects are achieved in a standard chuck having a chuck body centered on an axis and formed with a rear axially open mounting hole, a front axially open tool recess, a passage extending axially between the hole and the recess, and a plurality of angled guide passages spaced about the axis and opening into the recess. Respective jaws displaceable generally axially in the passages each have a row of radially outwardly directed teeth and a tightening ring rotatable about the axis but axially fixed on the chuck body has an internal screwthread meshing with the teeth of the jaws. According to the invention the chuck body has inner and outer nitrided surfaces hardened by nitrocarburizing.

Nitrocarburizing produces a surface that is so slick that particles cannot adhere to it. Thus the chuck clears itself of any drilling grit as it spins during a drilling operation. The nitrocarburizing can be done by the gas or plasma process, but is preferably done by a salt-bath method which subjects the chuck body to substantially less thermal stress. Thus nitrocarburizing is used not only to harden the chuck-body surfaces and thereby reduce wear to them, but also to make even the surfaces not subject to any substantial wear so smooth that drilling grit will not clump up and stick to them.

The increase of the wear resistance works synergistically to better carry away drilling grit since for example the increased hardness of the rear end of the chuck body prevents the spindle from biting into the body surfaces so that the screw projecting backward from inside the chuck body into the spindle does not get loose. Furthermore grit getting between this retaining screw and its seat will not cause wear, but instead will slide out, also eliminating wear at this site. In general the hardened chuck-body surfaces are much less liable to be marred or damaged to provide rough areas that are good sites for the adherence of clumps of abrasive drilling particles.

### BRIEF DESCRIPTION OF THE DRAWING

The above and other objects, features, and advantages will become more readily apparent from the following description, reference being made to the accompanying drawing in which:

FIG. 1 is a side view partly in axial section through a chuck according to the invention;

FIG. 2 is a section taken along line II-II of FIG. 1;

FIG. 3 is a view like FIG. 1 of the chuck with the jaws retracted somewhat more deeply than in FIG. 1;

FIG. 4 is a section taken along line IV-IV of FIG. 3;

FIG. 5 is a view like FIG. 1 of the chuck while holding a drill bit;

FIG. 6 is an end view taken in the direction of arrow VI of FIG. 5;

FIG. 7 is a side view of the chuck body in accordance with the invention;

FIG. 8 is an axial section through the chuck body of FIG. 7; and

FIG. 9 is an end view taken in the direction of arrow IX of FIG. 7.

### SPECIFIC DESCRIPTION

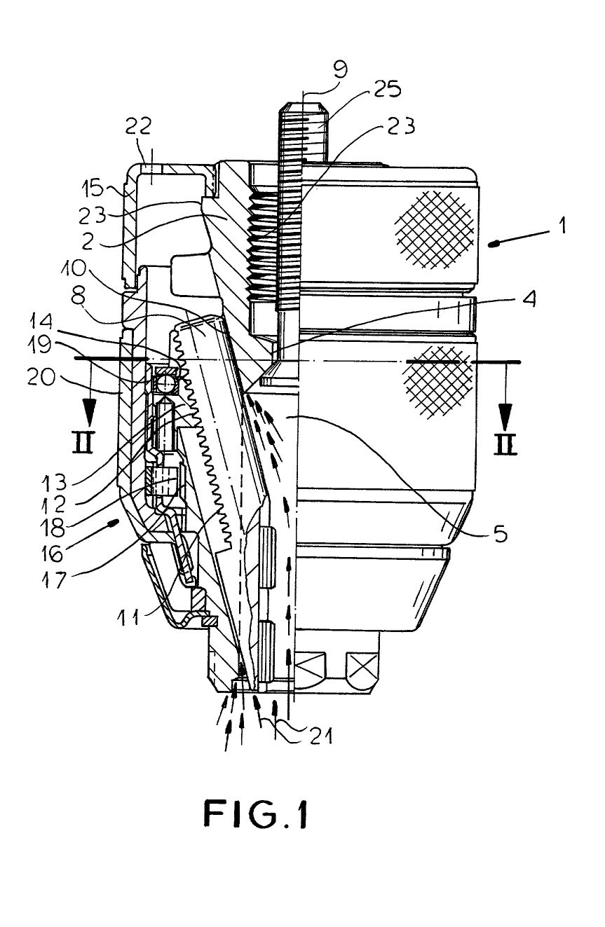

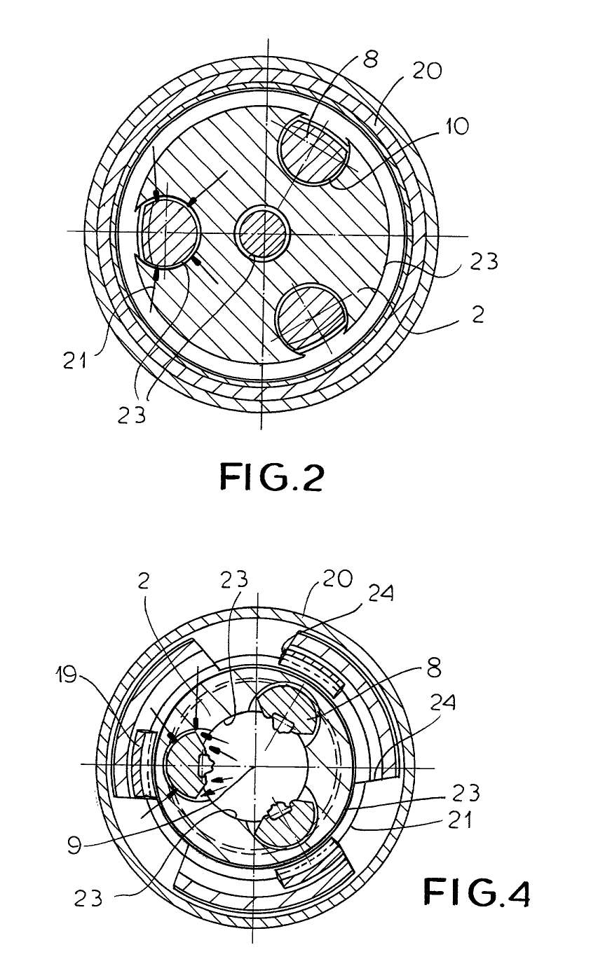

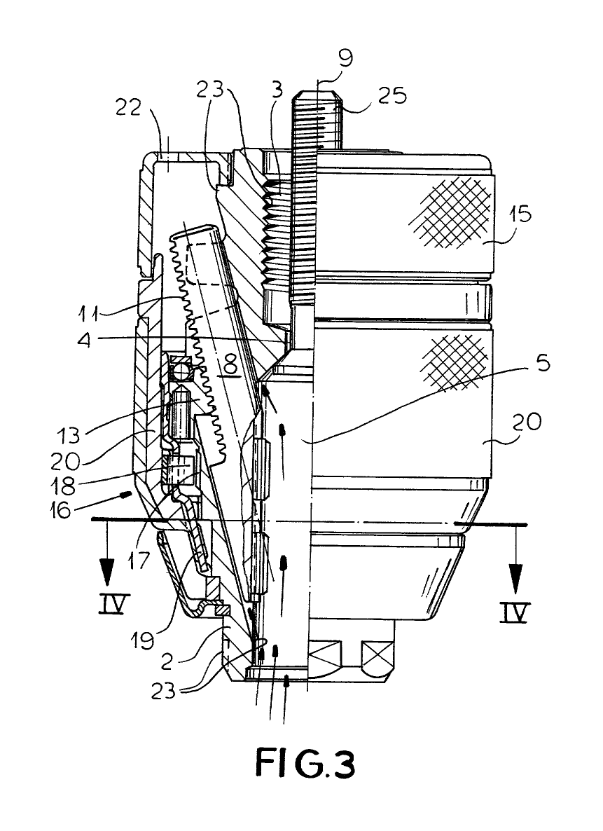

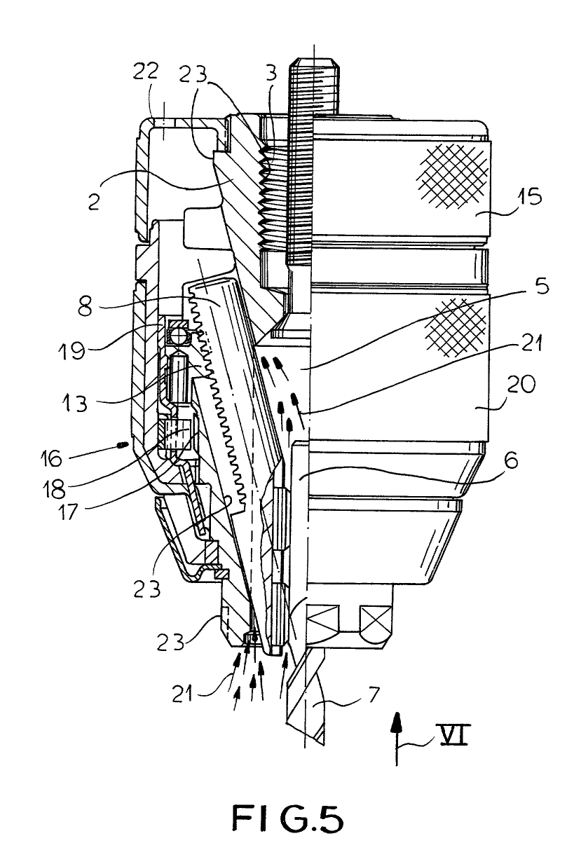

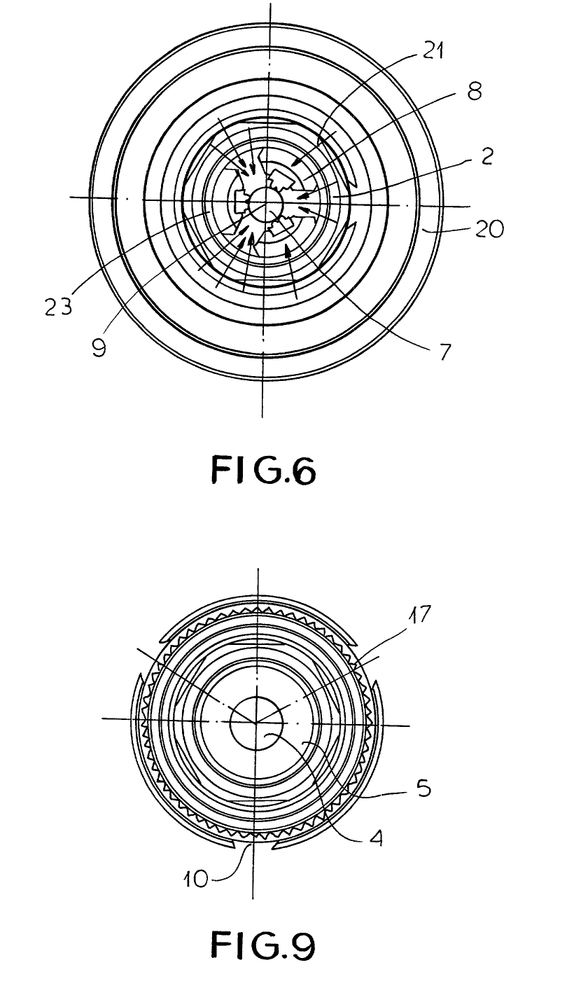

As seen in FIGS. 1 through 4, a drill chuck 1 has a steel chuck body 2 at whose axial rear end is a spindle hole 3 adapted to be mounted on the spindle of a drive unit for rotation of the body 2 about its axis 9. A passage 4 extends along the axis 9 from the spindle hole 3 to a tool recess 5 open at the front end of the body 2 and serves either for securing the body 1 via a bolt 25 to the drive spindle or for accommodating a hammer rod acting on the rear end of a shaft 6 of a tool 7 (FIGS. 5 and 6) gripped by jaws 8 in the recess 5. These jaws 8 ride in guide passages 10 that extend at an angle to the axis 9 and rear edges of the jaws 8 are formed with teeth 11 meshing with an internal screwthread 12 of a two-part tightening ring 13 that is rotatable but axially fixed in a radially outwardly open groove 14 the body 2.

The chuck 1 has a sleeve 15 much as described in U.S. Pat. No. 5,765,839 that is connected through a latching mechanism 16 to the ring 13. This mechanism 16 has a row of teeth 17 on the body 2 in which a latch member 18 can engage that is fixed in an intermediate sleeve 19 rotationally fixed to the tightening ring 13 and that can be set by a cam on an abutment 24 movable relative to an adjustable locking sleeve 20 limitedly movable on the intermediate sleeve 19.

Arrows 21 indicate how grit can get into the chuck during drilling. Holes 22 are provided on the sleeve 15 that permit it to exit at the back of the chuck 1, flung out by centrifugal force as the chuck 1 rotates about its axis 9. According to the invention in addition all of the external and internal surfaces 23 of the chuck body 2 are hardened by a nitrocarburizing process. This makes these surfaces 23 extremely hard so that none of the drilling particles will be able to dig into and adhere to them. Thus such particles will be easily cleared of the chuck 1.

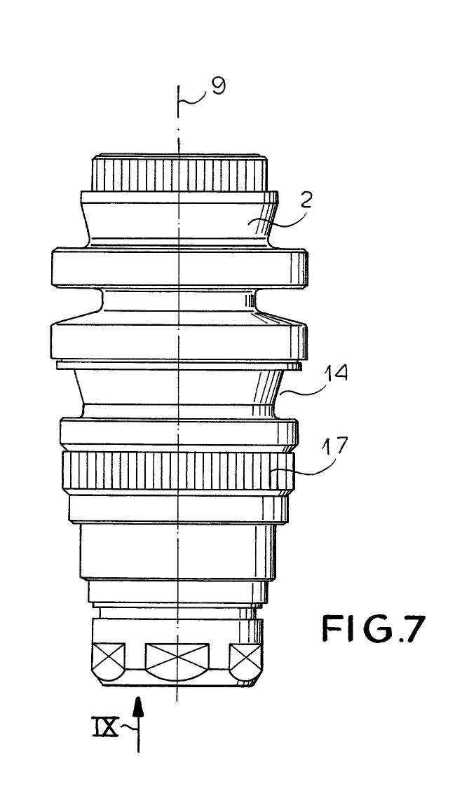

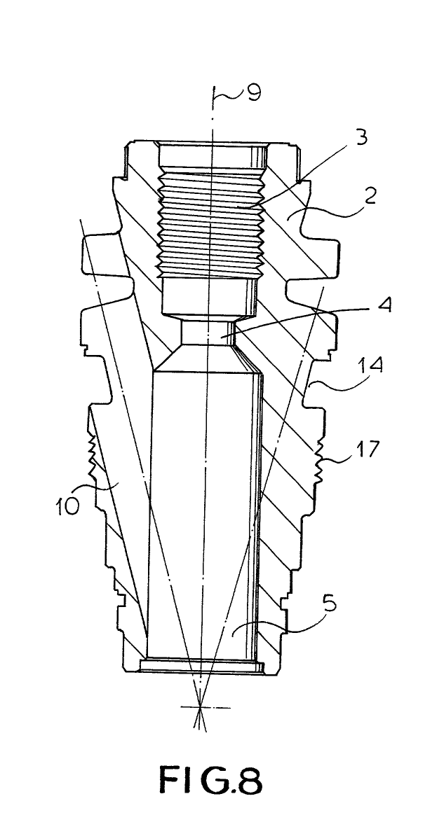

The nitrocarburizing process, carried out by the salt-bath method as described in “Durferrit Nitrocarburieren Tenifer TF1-AB1 ein Wärmebehandlungsverfahren mit vielseitigen Anwendungsmöglichkeiten” (G. Wahl; Hanau; 1995) is basically a cold process so that the finely machined body 2 is not subjected to substantial thermal stresses by this hardening treatment. Thus the complexly shaped body 1, shown in some detail in FIGS. 7 through 9, will not be deformed by the hardening process after it is machined.

What is claimed is:

1. In a chuck having:
a chuck body centered on an axis and formed with
a rear axially open mounting hole,
a front axially open tool recess,
a passage extending axially between the hole and the recess, and
a plurality of angled guide passages spaced about the axis and opening into the recess;
respective jaws displaceable generally axially in the passages and each having a row of radially outwardly directed teeth; and
a tightening ring rotatable about the axis but axially fixed on the chuck body and having an internal screwthread meshing with the teeth of the jaws, the improvement wherein
the chuck body has inner and outer nitrided surfaces hardened by nitrocarburizing.

2. The improved chuck defined in claim 1 wherein the hardened surfaces extend into the tool recess and guide passages.
